(19) United States
(12) Patent Application Publication
(10) Pub. No.: US 2016/0340534 A1
(43) Pub. Date: Nov. 24, 2016

(54) INKS, PIEZORESISTIVE SENSORS, AND CONDUCTIVE MATERIALS ON FLEXIBLE SUBSTRATES

(71) Applicant: Board of Regents, The University of Texas System, Austin, TX (US)

(72) Inventors: Muthu WIJESUNDARA, Fort Worth, TX (US); Caleb NOTHNAGLE, Arlington, TX (US)

(21) Appl. No.: 15/160,969

(22) Filed: May 20, 2016

Related U.S. Application Data
(60) Provisional application No. 62/165,882, filed on May 22, 2015.

(51) Int. Cl. C09D 11/52; B41J 2/07; G01L 1/18; B41J 2/035

(52) U.S. Cl. CPC C09D 11/52; B41J 2/035; B41J 2/07; G01L 1/18; B41J 2002/022

(57) ABSTRACT

New piezoresistive ink compositions are described herein. Such compositions can be used in printing applications and can be useful to print onto non-uniform surfaces. The ink compositions can be useful in strain-sensing devices, which may be applied to electrical appliances, electronic devices and in robotics. Such strain-sensing devices can be a flexible and transparent strain sensor or as a tactile sensor. Methods of making strain-sensing devices and other embodiments are also described.

### CROSS-REFERENCE TO RELATED APPLICATIONS

This application claims priority to U.S. Provisional Patent Application No. 62/165,882 filed May 22, 2015, the content of which is incorporated by reference in its entirety.

### STATEMENT REGARDING FEDERALLY SPONSORED RESEARCH OR DEVELOPMENT

This invention was made with government support under Grant No: NRI IIS-1208623 awarded by the National Science Foundation. The government has certain rights in the invention.

### FIELD OF INVENTION

The present invention relates generally to piezoresistive compositions. Such compositions can be useful in inject printing applications and for use in strain sensors.

### BACKGROUND

Electrical interconnects, electrodes, and sensors traditionally needed to be printed on surfaces to enable large-scale production and repeatability. In the recent years, due to miniaturization of appliances, the necessity of having to print on non-uniform surfaces has given rise to a need for development of new materials as the traditional inks do not print uniformly. Also, inks traditionally used for this purpose, for example, indium-tin oxide (ITO), can be difficult to print, have high resistivity issues when attempting to print over a large area, and are expensive to procure and to print. It should also be noted that traditional inks are generally mineral based inks or mineral oxide based inks and are becoming increasingly difficult and expensive to procure.

To overcome the above limitations of traditional inks, conductive polymer solutions are being researched and developed today. Compositions using poly(3,4-ethylenedioxythiophene) polystyrene sulfonate (PEDOT:PSS) have been explored to overcome the limitations of the traditional inks and have overcome many of the limitations of the traditional inks. In addition, they are easy to print, and have uniform properties over larger scales, and are flexible. However, the printability of the conventional PEDOT:PSS are limited by their physical properties such as viscosity, surface tension, and other physical and chemical properties due to the solvent materials, etc. This results in non-uniform printing characteristics, and, thus limits the use of these inks in a range of applications, for example, robotic skins, transparent displays, electrical interconnects, electrodes, and other sensors. Additionally, known PEDOT:PSS inks are generally water based, resulting in longer drying times. Longer drying times are detrimental when attempting to print in multiple layers, or when printing to conform to non-uniform surfaces.

### SUMMARY

A discovery has been made that provides a solution to the problems associated with PEDOT:PSS inks and conventional mineral based inks. The ink composition can include PEDOT:PSS, a solvent, a plasticizer, and a soluble conductive polymer. The ink composition can be used to form a piezoresistive layer in a strain sensing device. The ink composition describe herein can provide a desired viscosity, surface tension, and conductivity without undesirably sacrificing the transparency, conductivity, and piezoresistivity of the materials.

Some embodiments comprise an ink composition. An ink composition can comprise PEDOT:PSS, a solvent (e.g., N-alkyl-2-pyroolidones, N-methyl-2-pyrrolidone (NMP)), a plasticizer (e.g., polyvinylpyrrolidone (PVP)), and a soluble conductive polymer (e.g, sulfonated tetrafluoroethylene based fluoropolymer-copolymer (e.g., Nafion®, DuPont®, USA). The plasticizer can have an average molecular weight of 28,000 to 30,000, e.g., 29,000. The soluble conductive polymer can be solubilized in a mixture of lower aliphatic alcohols and water up to a concentration of 0.5 wt. % to 20 wt. % conductive polymer based on the total weight of the mixture. In some embodiments, the ink composition can have 30 to 40 parts by weight of PEDOT:PSS, and 60 to 70 parts by weight of solvent, up to 2.5 parts by weight of plasticizer and/or up to 1 parts by weight of a conductive polymer solution based on the total weight of the ink composition. The ink composition can comprise a viscosity of at least 50 Cps, a surface tension at or below 50 mN/m, and/or a sheet resistance of less than 13,000 Ω/sq. The ink composition can be a single phase solution.

Another embodiment can comprise an ink cartridge having a reservoir with the ink composition as described herein disposed within the reservoir. The ink cartridge can be configured to supply the ink composition to a printer.

Another embodiment can comprise a strain-sensing device. The device can include at least one non-conductive substrate layer, at least one conductive layer of electrodes wherein the positive and negative electrodes are not in direct contact, and at least one conductive piezoresistive layer disposed between the electrodes. The piezoresistive layer is coupled to the substrate and configured to elastically deform when the adjacent section of the substrate layer bends. The non-conductive substrate layer can be made of polymeric film (e.g., a polyimide film) and/or the electrodes can be made of one or more conductive metals (e.g., platinum). The conductive piezoresistive polymer layer can be formed from an ink composition that includes PEDOT:PSS, a solvent, a plasticizer, and a soluble conductive polymer. The conductive piezoresistive layer can comprise PEDOT:PSS, a plasticizer, and a soluble conductive polymer. In some embodiments, the piezoresistive layer includes 90 to 100 parts by weight of PEDOT:PSS, up to 6 parts by weight of PVP, and up to 2.5 parts by weight of sulfonated tetrafluoroethylene based fluoropolymer-copolymer after the ink has dried.

Other embodiments comprise method of making a strain sensor and can include applying the ink composition described herein to a substrate such that at least a portion of the applied composition is disposed between a positive electrode and a negative electrode. The ink composition can be applied with a printer, such as an ink jet printer.

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

The composition of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the composition of the present invention PEDOT:PSS, a solvent, a plasticizer, and a soluble conductive polymer.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears.

FIG. 1 illustrates a schematic diagram of a strain-sensing device.

FIG. 2(a) depicts certain components of one example of an EHD printer.

FIG. 2(b) depicts a cutaway cross-sectional side view of the nozzle of the printer of FIG. 2(a) during two operating modes.

FIG. 3 illustrates a schematic of an ink cartridge with an ink composition in accordance with the present disclosure disposed therein.

FIG. 4 illustrates (a) a strain sensing device with interdigitated comb electrodes, (b) a graph showing bending induced strain of the device shown in (a), which was tested by applying a force at an end of the device. The equation for calculating curvature of the device is also shown.

FIG. 5 shows Pt based electrodes with PEDOT:PSS printed on sensing area. For (a), the comb gap is 370 m⁻⁶, and for (b) the comb gap is 170 m⁻⁶.

FIG. 6 illustrates an embodiment of a strain sensor with print path of an ink composition starting on a conductive surface and transitioning over onto the non-conductive substrate.

FIG. 7 shows images of printing results of Ink 1 on gold coated glass substrate: (a) displays an image of printed lines at different printing speeds (2 line for each speed), (b) displays an image of a interconnected rectangular structures, and (c) a magnified image of each line in (a) with respective printing speed and line-width.

FIG. 8 shows close-up images of printing rectangular structures with (a) Ink 1 (b) Ink 2, and (c) Ink 3.

FIG. 9 shows resistance as a function of curvature for a strain-sensing device with larger (370 m⁻⁶) comb gap and formed from Inks 1, 2, and 3.

FIG. 10 shows resistance as a function of curvature for a strain sensing device with larger (370 m⁻⁶) comb and smaller (170 m⁻⁶) comb gap for (a) Example Ink 1 and (b) Example Ink 3.

### DESCRIPTION OF ILLUSTRATIVE EMBODIMENTS

In accordance with the current disclosure, an ink composition can be a solution comprising PEDOT:PSS and an organic solvent, e.g., an amine-type solvent. The composition can further comprise a plasticizer and/or a conductive polymer that is soluble in the organic solvent. PEDOT:PSS is a transparent, conjugated, and conductive polymer that is ductile, stretchable, and has good environmental stability.

The type and amount of the organic solvent can be varied to modify the viscosity and surface tension of the solution. The organic solvent can be an amine, a substituted amine, a cyclic amine or a substituted cyclic amine, or an aromatic amine, a substituted aromatic amine can be used having a boiling point (b.p.) at atmospheric pressure (1 atm) of at least 150° C. to 300° C., 170° C., 180° C., 190° C., 200° C., 210° C., 220° C., 230° C., 240° C., 250° C., 260° C., 270° C., 280° C., 290° C., 300° C., 310° C., 320° C., 330° C., 340° C., 350° C., 360° C., 370° C., or any range or value there between. Non-limiting examples of organic solvents include N-alkyl pyrrolidones such as N-cyclohexyl-2-pyrolidone (CHP) (b.p. 284° C.), N-ethyl-2-pyrrolidone (NEP, b.p. 212° C.), N-Methyl-2-Pyrrolidone(NMP, b.p. 202 to 204° C.), or N-octyl-2-pyrrolidone (NBP, 170 to 172° C.), dimethyl sulfoxide (DMSO, b.p. 372° C.), Dimethylformamide (DMF, b.p. 307° C.) solution may be used.

To increase the plasticity in the ink, it can further include a plasticizer, e.g., polyvinylpyrrolidone (PVP), PVP/vinyl acetate copolymer, polyamide resin, acrylic resin, styrene resin, phenol resin, keto-aldehyde resins, phenolic resin, polyvinyl butyral resin, and polyvinyl pyrrolidone resin.

However, the use of a plasticizer also can increase the resistivity of the resulting ink. To counter this effect, when needed, the ink can further comprise a soluble conductive material, e.g., a sulfonated tetrafluoroethylene based fluoropolymer-copolymer (e.g., Nafion® DuPont®, USA), a sulfonated poly(ether ether ketone), a sulfonated polyimide, or a solution comprising a soluble conductive material. The solution of soluble conductive material can be up to 20 percent sulfonated tetrafluoroethylene based fluoropolymer-copolymer (e.g., Nafion®). The solution can also comprise a mixture of lower aliphatic alcohols and water.

The ink composition can include 30 to 40 parts by weight of PEDOT:PSS and 50 to 70 parts by weight of the solvent. For example, the ink can include 30, 31, 32, 33, 34, 35, 36, 37, 38, 39, or 40 parts by weight of PEDOT:PSS, and the ink can include 50, 51, 52, 53, 54, 55, 56, 57, 58, 59, 60, 61, 62, 63, 64, 65, 66, 67, 68, 69, 70 parts by weight of the solvent. The ink can include 30 to 35 parts by weight of PEDOT:PSS and 64 to 66 parts by weight of the solvent.

The ink can also include of up to 2 parts by weight of the plasticizer. For example, the ink can include 0, 0.1, 0.2, 0.3, 0.4, 0.5, 0.6, 0.7, 0.8, 0.9, 1, 1.1, 1.2, 1.3, 1.4, 1.5, 1.6, 1.7 1.8, 1.9, 2.0 part by weight of the plasticizer. The ink can also include up to 1 part by weight of the soluble conductive material. For example, the ink can include 0.05, 0.1, 0.15, 0.2, 0.25, 0.3, 0.35, 0.4, 0.45, 0.5, 0.55, 0.6, 0.65, 0.7, 0.75, 0.8, 0.9, or 1 part by weight of the soluble conductive material.

The ink composition can comprise a viscosity of at least 45 Cps, a surface tension at or below 50 mN/m, and/or a sheet resistance of less than 13,000 Ω/square. For example, the viscosity at ambient temperature (e.g., 20-25° C.) can be at least 45, 50, 55, 60, 65, 70, or 75 Cps. The surface tension at ambient temperature (e.g., 20-25° C.) can be less than 50, 45, 40, 35, 30, 25, 20, or 15 mN/m. The sheet resistance can be less than 13,000; 12,500; 11,000; 10,500, 10,000; 9,500; 9,000; 8,500; 8,000; 7,500; 7,000; 6,500; 6,000; 5,500; 5,000 or 4,500 Ω/square.

The ink composition upon drying comprises PEDOT:PSS. The dried composition can further comprise a plasticizer and/or a conductive polymer. A majority of the organic solvent will evaporate. Upon drying, the ink composition can be transparent. For example, the dried ink can have at least 70%, 75%, 80%, 85%, 90%, or 95% transparency. The dried ink can have a gauge factor of 5 to 20, 8 to 17, or 10 to 15. Dried ink can have conductivity of 10-100% of pure PEDOT:PSS.

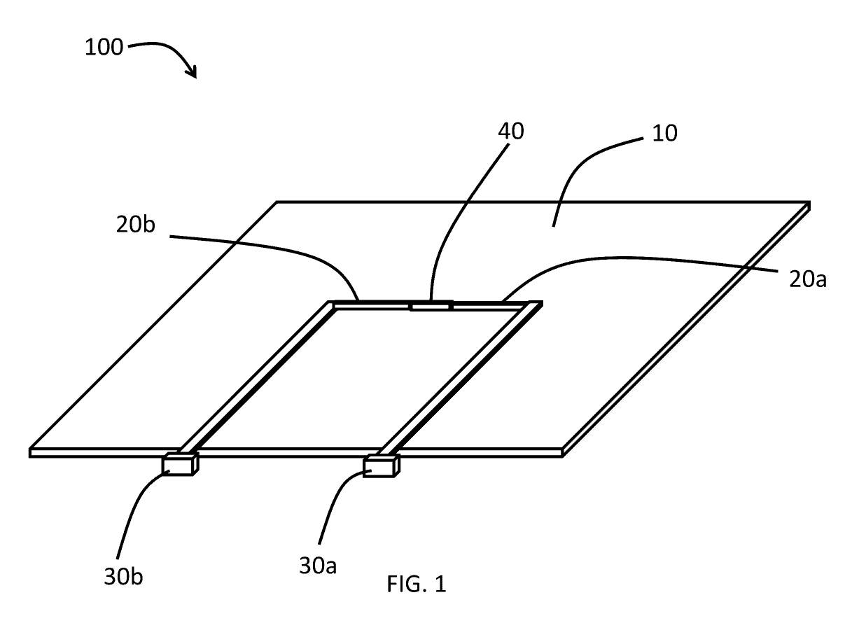

The ink composition can be used to form the piezoresistive material of a strain-sensing device. Referring to FIG. 1, an embodiment of a strain-sensing device is shown. Strain sensor 100 can comprise a substrate material 10; at least two conductive electrodes 20 disposed on or within the substrate layer; at least two conductive interconnects 30, each coupled to a corresponding conductive electrodes and configured to couple with a power supply; and a piezoresistive layer 40 disposed between the conductive electrodes. Piezoresistive layer 40 is configured to change its electrical resistivity upon the application of strain. Piezoresistive layer 40 can be formed from the above-described ink composition. Piezoresistive layer 40 can be the dried ink composition; e.g., the layer includes PEDOT:PSS, a plasticizer, and a soluble conductive polymer.

Electrode 20 and conductive interconnects 30 can include noble metals, such as platinum (Pt), gold (Au), ruthenium (Ru), rhodium (Rh), palladium (Pd), silver (Ag), osmium (Os), or iridium (Ir).

Substrate material 10 can be a non-conducting yet flexible material, such as, but not limited to, a polymeric film or sheet. Substrate material 10 can be a polyimide film. Polyimides are commercially available from E.I. DuPont under the tradename of Kapton®.

Flexible and transparent strain-sensing devices 100 can have a range of applications including use in electrical appliances, electronic devices, and robotics. For example, their application can range from being a strain sensor to detect deformation of structures, or as a stress sensor wherein the stress on a structural component may be determined as a factor of the strain, or as a touch sensor.

An example of use of the flexible strain-sensing devices 100 in robotics is application as robotic skins. Robotic skins have to be flexible to accommodate for the movement of the robotic joints while still maintaining sensitivity to tactile input and other sensory information. They may also need to be integrated with other multi-modal sensors to provide rich and sophisticated sensory information in human-robot co-existence. Robots equipped with sensory skins for real time feedback are not only safer for humans, but they may also perform tasks more efficiently and successfully in unstructured and dynamically changing environments. Tactile data may be for multiple applications, for example to implement human-guided behavior learning [1], improve safety [2], interpret human intent [3], or ensure operation in cluttered environments [4]. Further the use of tactile feedback in closed-loop feedback may be further beneficial. Useful sensory information for sensitive robotic skins include, but are not limited to pressure, tapping, temperature, and proximity.

Conventional sensor fabrication methods based on semiconductor manufacturing are not ideal for multi-modal sensor arrays on large, flexible, and uneven substrates like robotics skins. Additive manufacturing can be used for sensor fabrication on substrates with various sizes, shapes, and complex topographies. An example of additive manufacturing suited for these applications is printing. Printing can allow for a range of inks to be used in the fabrication process. An advantage of printing is that it can enable multi-modal sensor fabrication. Inkjet printing is one such technique that can be employed in multiple sensor manufacturing stages. Most modern sensors require multiple sensor manufacturing stages, for example in direct device printing, mask-less lithography, and packaging. Additionally, additive manufacturing, especially by printing uses only the adequate amount of material needed and is thus provides an efficient and economical process for fabrication. Thereby, minimizing the manufacturing material lost to wastage.

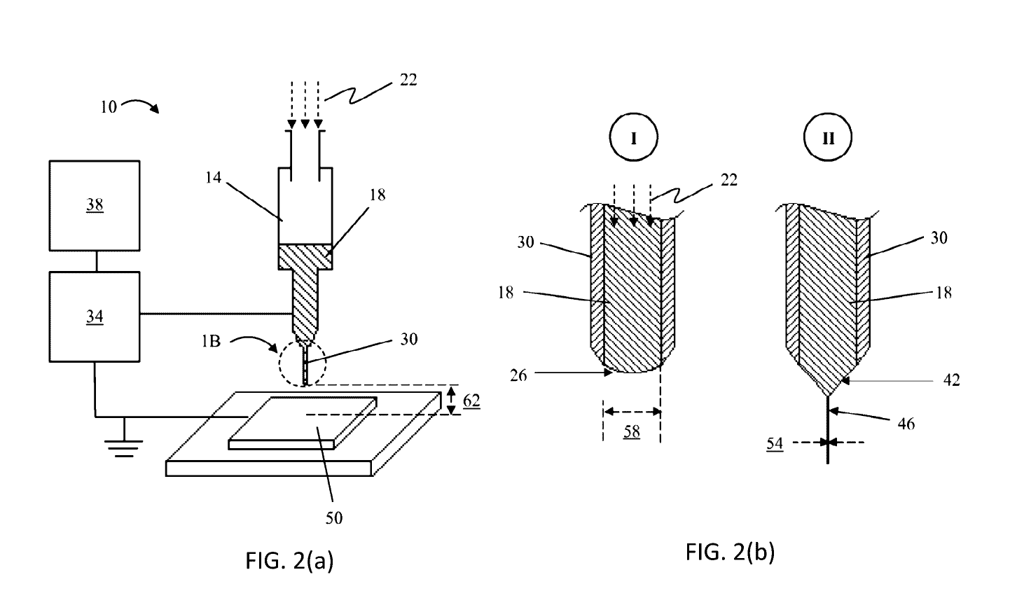

The piezoresistive layer can be formed by printing with the ink composition described herein using a printer, such as with an electro-hydrodynamic (EHD) inkjet printing system. An embodiment of a printer is shown in FIGS. 2(a) and 2(b). FIG. 2(a) depicts certain components of an illustrative example of an EHD printer 10; and FIG. 2(b) depicts cutaway cross-sectional side views of a nozzle of printer 10 in two operating modes. Typically, EHD printers work by using a strong electric field to cause the ejection of printing media onto a substrate. For example, as shown, printer 10 comprises a reservoir 14 which can contain ink composition 18 as described herein. EHD printing is desirable, in part, due to its ability to print micro- and nano-scale features. Pressure (e.g., indicated by arrows 22) can be internally applied to reservoir 14 to create a meniscus 26 at the exit of nozzle 30 (e.g., in printer 10, which includes a gold coated glass capillary with a 10 micrometer (μm) inner diameter), which is in fluid communication with reservoir 14 (e.g., as shown in operating mode I of FIG. 1B). A large bias voltage, which can be supplied by power supply 34 (which can include and/or be controlled by a function generator 38), can be applied to nozzle 30. Through application of bias voltage, meniscus 26 can form into cone 42 and printing media 18 can be ejected as jet 46 (e.g., a continuous jet during printing operation) onto substrate 50. For example, as bias voltage is applied to nozzle 30, a voltage difference between substrate 50 and nozzle 30 can be realized. Mobile ions in printing media 18 can accumulate at the surface of meniscus 26 where mutual Coulombic repulsion and electrostatic attraction to substrate 50 can create tangential stress on meniscus 26, resulting in the formation of cone 42 (also known as a Taylor cone) (e.g., as shown in operating mode II). When the bias voltage is sufficiently high, the tangential stress can overcome the surface tension of ink 18 at the surface of cone 42, and the ink can be ejected towards substrate 50. By controlling the ink characteristics (e.g., viscosity, surface tension, conductivity and/or the like), stand-off distance 62 (e.g., the distance between nozzle 30 and substrate 50), pressure 22 (e.g., back pressure), bias voltage, nozzle characteristics (e.g., inner diameter 58, shape, and/or the like) and/or the like, ejection characteristics can be adjusted. For example, as shown in operating mode II, ink 18 is ejected as stable jet 54. However, ejection characteristics (e.g., flow rate, jet diameter, stability, and/or the like) can vary, to include, without limitation, droplets, whipping (e.g., unstable) jets, and/or the like. As shown, during EHD printing, diameter 54 of jet 46 can be significantly smaller (e.g., up to two orders of magnitude) than nozzle 30 exit diameter 58.

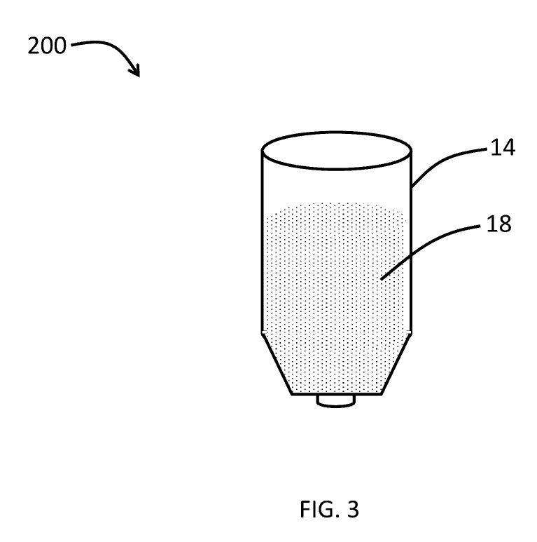

With reference to FIG. 3, an ink cartridge is shown. Ink cartridge 200 can be configured to supply ink to a printer such as EHD printer 10. An ink cartridge can comprise a reservoir 14 wherein the ink composition 18 as described herein is disposed.

A method of forming a strain-sensing device like that shown in FIG. 1 can comprise applying the ink composition described herein to a substrate such that at least a portion of the applied composition is disposed between a positive electrode and a negative electrode. The ink composition can be applied with a printer, such as EHD printer 10.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Ink Formulations

Three different types of EHD printing inks are exemplified using PEDOT:PSS as a primary material. High viscosity screen printing PEDOT:PSS paste was dissolved in NMP to obtain desired ink characteristics including low viscosity and low surface tension. NMP was selected due to its low surface tension and high boiling point (202 to 204° C.). A high boiling point allows repeatable printing with no drying of ink in the print nozzle. The weight-to-weight composition of each ink is shown in Table I. Ink 1 contains only PEDOT:PSS and NMP. For Ink 2, PVP with an average molecular weight of 25,000 to 35,000, was added to Ink 1 to reduce the aggregation of PEDOT:PSS in the solution. As PVP typically reduces the conductivity due to its dielectric nature, Nafion was added to Ink 2 to improve the conductivity of Ink 3. All chemicals, with the exception of Nafion, were purchased form Sigma-Aldrich while Nafion was obtained from Ion Power, Inc.

TABLE I
weight-to-weight (W/W) composition of inks

| Ink | PEDOT:PSS | PVP | 5% Nafion | NMP |
|---|---|---|---|---|
| 1 | 2 | 0 | 0 | 4 |
| 2 | 2 | 0.125 | 0 | 4 |
| 3 | 2 | 0.125 | 1 | 4 |

Ink 1 forms the basic ink that is printable. Also, the high boiling point of NMP makes these ink formulations less susceptible to heating issues. However, the addition of PVP in Ink 2 helps reduce the aggregation of the PEDOT:PSS paste in the NMP solution. This helps the ink to maintain consistency of its composition and also adds to the uniformity of the printed product's composition. Further to the composition of Ink 2, the Nafion solution added to Ink 3 helps counter some of the increased electrical resistivity that is caused by the introduction of the PVP. Increased electrical resistivity would decrease the sensitivity of the sensor. On the flip side, this helps increase the reliability of the sensor. Thus by varying the content of the plasticizer and the soluble conductive material, one may tune the characteristics of a sensor. A simple tactile sensor, for example one that is to act as a switch, may not need to be as sensitive as it is accurate. However a strain sensor, for example in a robotic skin application, may need to be both accurate and highly sensitive.

### Example 2

### Electro-Hydrodynamic Printing

Electro-hydrodynamic (EHD) inkjet printing system may be selected to fabricate a strain sensor.

EHD printing involves the application of an electric field to a nozzle in order to dispense a thin jet of fluid, orders of magnitude smaller than the nozzle tip, onto a substrate. FIG. 2(a) shows the setup of an EHD inkjet printing system. Using back pressure in the ink cartridge, a meniscus of liquid can be formed at the nozzle tip which the applied electrical field can then pull into a thin stream. The resulting dispensed fluid can be jetted continuously or pulsed and, when used in conjunction with Computer Numerically Controlled (CNC) staging can form a printed pattern or mask with high repeatability.

EHD is capable of printing materials with a viscosity of up to 1000 cP, as opposed to the 50 cP limit present in conventional piezoelectric printing methods. Thicker inks can also yield printed microstructures of higher density with fewer overlaid passes and the expanded suite of materials can provide for a more diverse multi-modal sensor. The only considerable disadvantage of the EHD method is its requirement of a ground electrode to print over though this can be overcome with slight modifications to the print path, substrate, or even the print head.

Printing of the inks involved characterizing and selected a variety of process parameters including voltage, feed rate, offset of the nozzle tip from the substrate surface, and back pressure. For the examples described here, successful printing of each ink was obtained using a tip voltage of 2000 V, a feed rate of 6 mm/s, and a surface offset of 800 m⁻⁶. Back pressure was adjusted to optimize the tip meniscus conditions on a print-by-print basis varying from 0.5 to 1.2 kPa.

### Example 3

### Sensor Design

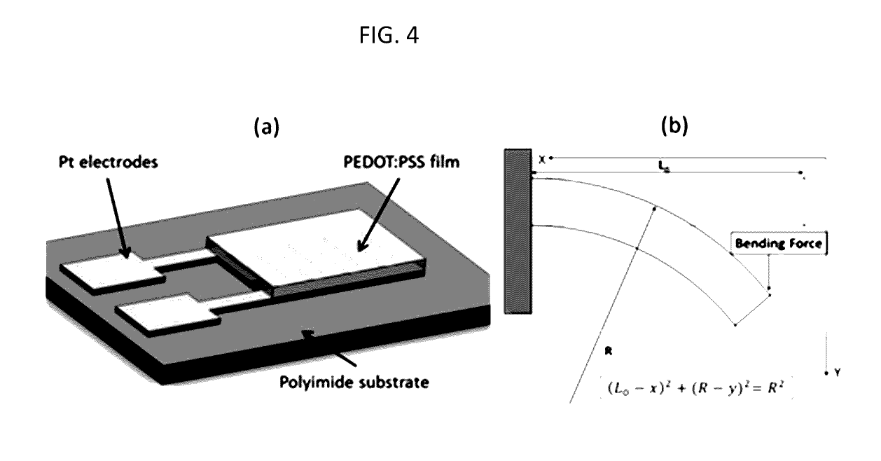

A strain-sensing device comprising an interdigitated comb electrode design disposed on a polyimide substrate was used as a test structure for this example. The ink composition was deposited over the combs (FIG. 4(a)) to complete a circuit between the interdigitated electrodes. The test structure was bent along the length of the device by applying a force to the tip of the device as shown FIG. 4(b). The coordinates of the tip was measured with precision stage movement in the test setup and converted to the curvature (1/R) using the formula shown in the figure. The gap between comb teeth increases upon bending leading to strain in the ink film, thereby increasing the resistance between the interdigitated electrodes. The changes the device's resistance was measured as a function of curvature to evaluate the ink's response to strain.

Two differing geometries of example electrode structures were tested with each structure having the same sensing area (6 mm²), but different pitch and number of comb teeth. The key variable that affects the resistance of each test structure was the gap between combs teethes. FIG. 5 shows the optical images of these two test structures with Ink 1 printed on the sensing area. The gaps between comb teeth were 320 and 170 μm for structures shown in FIGS. 5(a) and (b), respectively. Overall, thirteen data points including initial resistance of the device were collected with the curvature changing from 0 to 0.45 mm⁻¹. All the inks were evaluated with same procedure with nearly identical thickness, namely, a 700 μm film.

### Example 4

### Sensor Fabrication

The interdigitated comb electrode design exemplified was fabricated using conventional lithographic techniques. This process began with the cleaning of a pre-fabricated Kapton® sheet using a sequence of IPA, acetone, and water to remove any contamination from the sheet which was then attached to a silicon support wafer and patterned. A sputtering and liftoff process was used to deposit a 20 nm Ti adhesion layer and 250 nm Pt electrode layer. The resulting metal electrodes on a Kapton® sheet formed the substrate, the electrical interconnects and the electrodes. The ink may was added on to the electrodes, for example by printing.

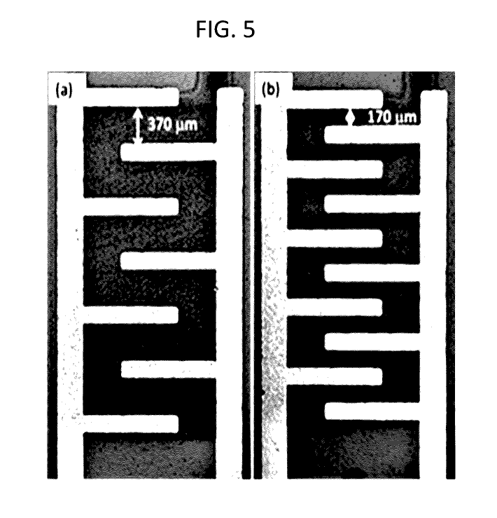

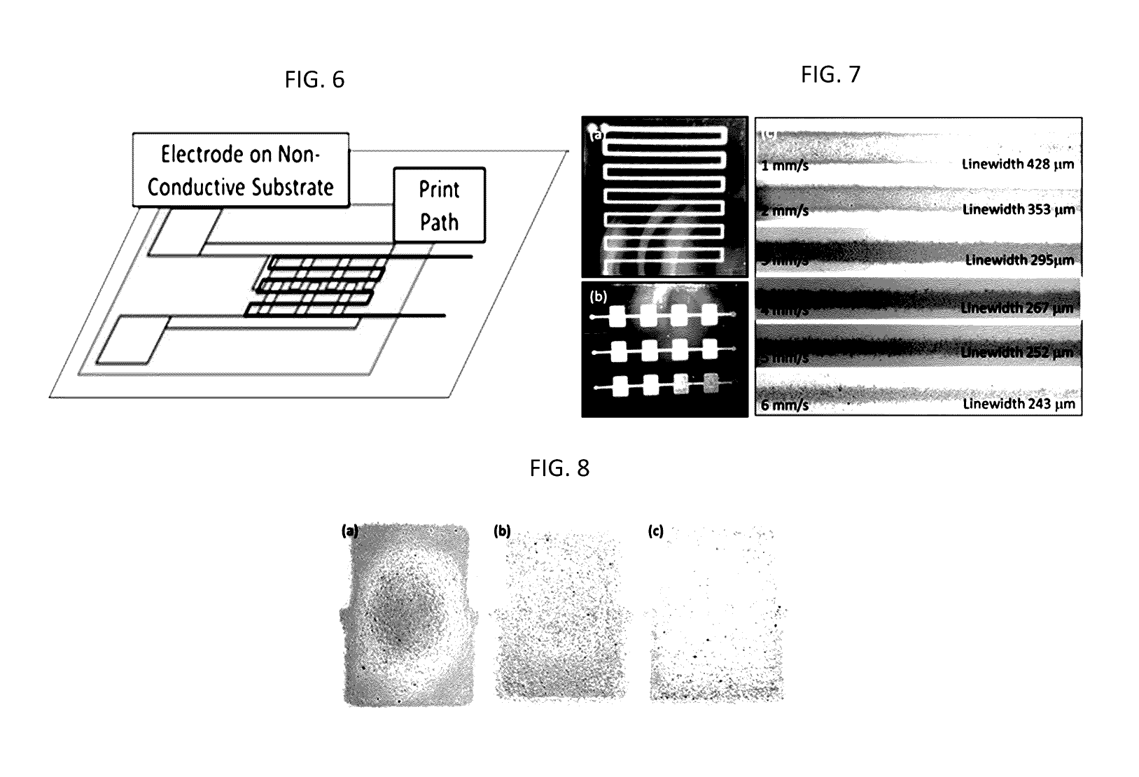

EHD printing involves designing a print path that would cover the interior area of the comb teeth with a uniform layer of ink while neither applying too much, causing overflow, nor too little, leaving gaps in the film. For example, as can be seen in FIG. 6, a raster scan printing path is selected to print ink lines perpendicular to the comb teeth with a 0.1 mm step over to ensure overlapping lines and even coverage of the ink at the selected feed rate of 6 mm/s. This path may be further optimized to address the specific grounding requirements of the EHD method. To achieve EHD printing on a Kapton® substrate, it was attached to a conductive substrate where the jetting may begin. This print run was transitioned over the grounded conductive surface onto the non-conductive Kapton® substrate where the grounded path was essentially extended by the fluid trace. Printing may then proceed as normal and stop at any point. Alternatively, the electrode traces themselves could be externally grounded to create a starting point within the Kapton® substrate. Upon completion, the sensors were singulated, wire bonded, and adhered to a glass slide for testing using UV epoxy. Care was taken during singulation to cut the electrodes along the outer boundaries of the metal traces.

### Example 5

### Ink Characteristics

Three different example ink formulations are described herein. The basic characteristics of EHD-printable ink includes high viscosity (50 Cps or above), low surface tension (below 50 mN/m) and a single phase solution. Specific to strain sensor fabrication, printed PEDOT:PSS contained in the ink should retain its electrical properties and be able to produce a thin film microstructure with a thickness of 1-2 μm. Table II shows the basic properties of three inks exemplified here. The high viscosity PEDOT:PSS screen printable paste were diluted with NMP to reduce the viscosity to desirable levels. Most common commercially available PEDOT:PSS solutions are solely water based and have high surface tension. NMP was selected because of its low surface tension in comparison to water (NMP 40 mN/m, Water 72 mN/m at 25 Degree Centigrade) as well as its known capacity to increase the conductivity of PEDOT:PSS. Additionally, NMP evaporates at a relatively high rate under heat allowing for easy deposition of multiple superimposed print runs to increase device layer thickness. The plasticizer (e.g., PVP) substantially reduces the aggregation effect and improves printing characteristics of the ink. For Ink 2, 6.25% (PVP to PEDOT:PSS by weight) of PVP was added and its effect was investigated. As expected, the addition of PVP reduced the conductivity of the ink; however, no significant change in surface tension was observed. Modifying the Ink 2 formulation with Nafion, an ionic polymer, yielded Ink 3 with reduced sheet resistance in comparison to Ink 2. In addition to affecting the conductivity, Nafion also reduceed the overall surface tension of the ink due to surfactants in the Nafion solution.

TABLE II
Properties of EHD inks developed for this investigation

| | Viscosity (cP) | Surface Tension | Sheet Resistance |
|---|---|---|---|
| Ink | at 24° C. | (mN/m) 24° C. | (Ω/□) |
| Ink 1 | 46.88 | 41.80 | 4590 |
| Ink 2 | 63.17 | 40.38 | 12489 |
| Ink 3 | 68.33 | 16.23 | 7256 |

### Example 6

### Printing Characteristics

All three inks were printable using the same printing parameters and produce high fidelity printed structures. FIGS. 7(a) and (b) shows the images of printed lines and an array of rectangular structures using Ink 1 on a gold coated glass substrate. Inks 2 and 3 also yield similar results with slight changes to line-width and their thickness profile. Large liquid volumes on the surface would result in surface tension driven restructuring before drying. Therefore, printing speed was varied to control the amount of ink dispensed onto a unit area. FIG. 7(c) shows the effect of printing speed variation on line-width. As the printing speed increases, the line-width decreased; however it should be noted that line-width reduction becomes less pronounced at speeds above 4 mm/s suggesting that there is no spreading of the ink after printing. Thickness profile data of lines also showed better uniformity at higher speeds. Based on both line-width and thickness profile uniformity, a printing speed of 6 mm/s for our sensor fabrication was selected.

FIGS. 8(a) and (b) show the optical images of rectangles printed with one layer of each ink. All inks produced fairly uniform PEDOT:PSS coverage over the printed area. The average thickness of the printed rectangular shapes is 156, 290, and 140 m⁻⁶ for Inks 1, 2, and 3 respectively. The interference pattern seen in the images, along with surface profile data, indicate a thickness variation from the edge to the middle of the structure for Inks 1 and 2 while Ink 3 gives a highly uniform thickness over the entire printed area. These thickness profile variations in FIGS. 8(a) and 8(b) are a result of post-print restructuring due to high surface tension of the printed inks. Viscosity and the solvent evaporation rate of these inks also contribute to the degree of restructuring. In these experiments, all three inks contain the same solvent; therefore, the solvent evaporation rate can be assumed to be the same. As a Nafion ink used to print the structure shown in FIG. 8(c) has the lowest surface tension, surface driven restructuring is not observed and consequently produces a highly uniform film.

### Example 7

### Sensor Characteristics

The above exemplified printed stain-sensing devices are characterized for their initial resistance before undergoing curvature based resistance experiments. Results are tabulated in Table III. The resistance of the devices for each ink follows the same trend observed in sheet resistance values. As expected, the strain-sensing devices with smaller gaps between combs have lower resistivity in comparison to larger gap comb structures. For both Inks 1 and 3, a very stable resistance reading may be observed. The resistance of the strain-sensing devices with Ink 2 fluctuated heavily presumably due to composition of the ink which contained highly resistive PVP.

TABLE III
Resistance of test structures before curvature based experiments

| | Sensor 1 (Comb Gap 170 μm) | Sensor 2 (Comb Gap 370 μm) |
|---|---|---|
| Ink | Resistance (Ω) | Resistance (Ω) |
| 1 | 28 | 55 |
| 2 | 599 | 1615 |
| 3 | 225 | 661 |

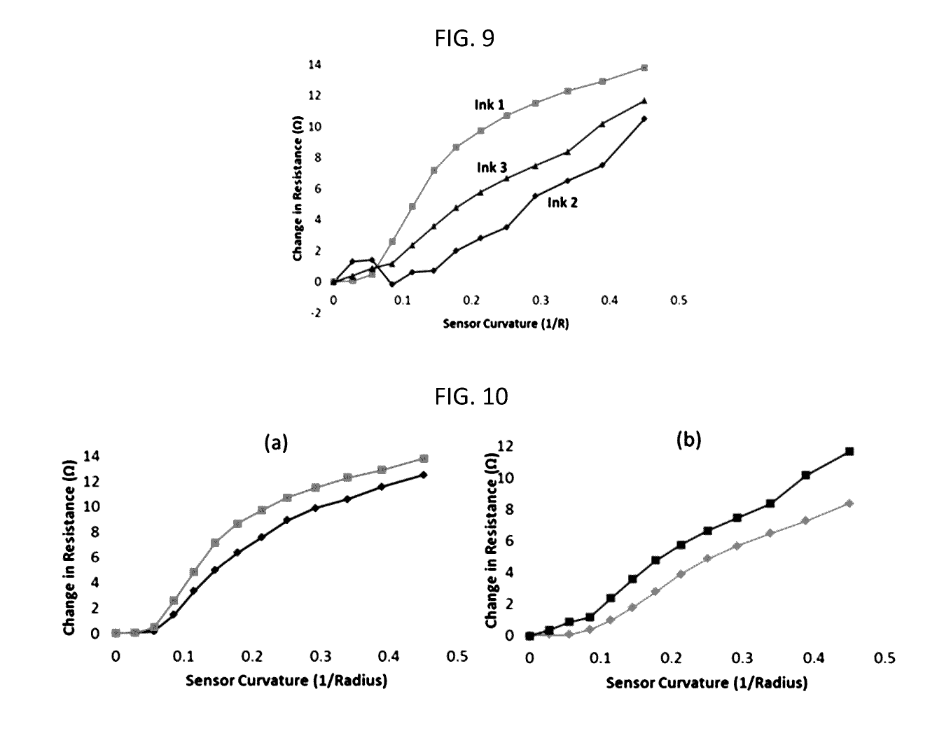

FIG. 9 data shows the resistance changes as a function of the curvature for sensor 2 and the data shows that all inks respond to the curvature induced strain. At lower curvature, the sensitivity is low for the test structure made with Ink 1; however, the sensitivity rapidly increases at a curvature above 0.06 mm⁻¹. The ink has two linear regions within the tested curvature range. The first region at curvature 0.06-0.15 mm⁻¹ has a better sensitivity in comparison to the second region 0.25-0.45 mm⁻¹. Among all three inks, Ink 3 seems to have better linearity in the entire region tested. Similar to initial resistance data, strain-sensing devices formed with Ink 2 have relatively high noise levels and the suitability of this ink for producing piezoresistance-based strain transducers is questionable.

Based on initial characterization results, Inks 1 and 3 were selected for further testing of their behavior. FIGS. 10(a) and (b) shows the comparison of the two strain-sensing devices response to curvature induced strain. Data clearly shows that the larger gap comb structure has a higher response in comparison to the smaller gap comb structure for both inks. This is expected due to resistance being proportional to the spacing between electrodes. Any strain induced resistance increase should thus show higher change in a larger gap structure. Therefore, these inks along with changes in sensor element geometry can be implemented for realizing sensors with different sensitivities. Most importantly, the sensitivity as well as linearity of these two inks follows the same trend regardless of the geometrical changes of the test structure. Therefore, Ink 1 and 3 can be implemented for EHD printing based sensor fabrication. Also, these inks may be used for other inkjet printing based sensor manufacturing with appropriate modification to viscosity and surface tension.

The devices, methods, and inks of the current disclosure provide a number of advantages over known strain sensors, e.g., uniform piezoresistivity, conductivity, and transparency while enabling simplified, accurate, and precise fabrication.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the devices are not intended to be limited to the particular forms disclosed. Rather, they include all modifications and alternatives falling within the scope of the claims, and embodiments other than the one shown may include some or all of the features of the depicted embodiment. For example, components may be omitted or combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. An ink composition comprising:
PEDOT:PSS, an organic solvent, a plasticizer, and a soluble conductive polymer.

2. The ink composition of claim 1, wherein the solvent is an amine, a substituted amine, a cyclic amine or a substituted cyclic amine, or an aromatic amine, a substituted aromatic amine.

3. The ink composition of claim 1, wherein the solvent is an N-alkyl pyrrolidone.

4. The ink composition of claim 3, wherein the N-alkyl pyrrolidone is N-methyl pyrrolidone (NMP).

5. The ink composition of claim 1, wherein the plasticizer is polyvinylpyrrolidone (PVP).

6. The ink composition of claim 1, wherein the plasticizer has an average molecular weight of 28,000 to 30,000.

7. The ink composition of claim 1, wherein the soluble conductive polymer is sulfonated tetrafluoroethylene based fluoropolymer-copolymer.

8. The ink composition of claim 1, wherein the soluble conductive polymer is up to 20 percent conductive polymer in a mixture of lower aliphatic alcohols and water.

9. The ink composition of claim 1, comprising:
30 to 40 parts by weight of PEDOT:PSS, and
60 to 70 parts by weight of solvent.

10. The ink composition of claim 1, comprising:
30 to 33 parts by weight of PEDOT:PSS,
up to 2.1 parts by weight of plasticizer, and
60 to 65 parts by weight of solvent.

11. The ink composition of claim 1, comprising:
30 to 35 parts by weight of PEDOT:PSS,
up to 2 parts by weight of plasticizer,
up to 1 parts by weight of soluble conductive polymer, and
60 to 70 parts by weight of solvent.

12. A strain-sensing device with a piezoresistive layer formed from the ink composition of claim 1, the system comprising:
at least one non-conductive substrate layer,
at least one conductive layer comprising at least one positive electrode and at least one negative electrode, wherein the positive and negative electrodes are not in direct contact with each other, and
the piezoresistive layer disposed on the substrate between the positive electrode and the negative electrode.

13. The device of claim 12, wherein the non-conductive substrate layer is comprise polymeric film.

14. The device of claim 13, wherein the polymeric film is a polyimide film.

15. A strain-sensing device for sensing strain comprising:
at least one non-conductive substrate layer,
at least one conductive layer comprising at least one positive electrode and at least one negative electrode, wherein the positive and negative electrodes are not in direct contact with each other, and
the piezoresistive layer disposed on the substrate between the positive electrode and the negative electrode, wherein the conductive piezoresistive layer comprises PEDOT:PSS, a plasticizer, and a soluble conductive polymer.

16. The device of claim 15, wherein the piezoresistive layer is coupled to the substrate and configured to elastically deform when the substrate layer bends.

17. The device of claim 16, wherein the piezoresistive layer comprises:
90 to 100 parts by weight of PEDOT:PSS,
up to 6 parts by weight of PVP, and
up to 2.5 parts by weight of sulfonated tetrafluoroethylene based fluoropolymer-copolymer.

18. A method of making a strain-sensing device comprising
applying an ink composition to a substrate such that at least a portion of the applied ink composition is disposed between a positive electrode and a negative electrode,
wherein the ink composition comprises PEDOT:PSS, a solvent, a plasticizer, and a soluble conductive polymer.

19. The method of claim 18, wherein the solvent is NMP, the plasticizer is PVP and the soluble conductive polymer is a sulfonated tetrafluoroethylene based fluoropolymer-copolymer.

20. The method of claim 18, wherein the strain-sensing device is an electro-hydrodynamic ink jet printer.
